(19) United States
(12) Patent Application Publication
(10) Pub. No.: US 2023/0321560 A1
(43) Pub. Date: Oct. 12, 2023

(54) SUBMERGED, CONDENSING, DIRECT CONTACT, PHASE SHIFTING HEAT TRANSFER PROCESS

(71) Applicant: James Jeffrey Harris, Cameron Park, CA (US)

(72) Inventor: James Jeffrey Harris, Cameron Park, CA (US)

(21) Appl. No.: 17/716,567

(22) Filed: Apr. 8, 2022

(51) Int. Cl. B01D 1/14; F28C 3/08; B01D 1/00

(52) U.S. Cl. CPC B01D 1/14; B01D 1/0041; F28C 3/08

(57) ABSTRACT

A heat transfer process focused for heat transfer with a potentially scaling, fouling, solids laden or otherwise aggressive fluid employing direct thermal contact between said fluid and an immiscible, phase shifting working media wherein said phase shifting proffers the employ of the latent heat of vaporization for protraction of the heat transfer process. Wherein further said phase shifts modify the working media density therein motivating the immiscible, direct contact fluid dynamics.

### BACKGROUND OF THE INVENTION

The art of the present invention relates to a heat transfer process and associated embodiments for heating a thermal receiving fluid by means of flowing direct contact with a heated, immiscible liquid/vapor phase shifting working media, wherein the dynamics of said flowing contact is motivated via thermally induced density differentials between the immiscible vapor/liquid working media and the thermal receiving fluid. Wherein further, the immiscible direct contact heating of the thermal receiving fluid involves no solid surface regions of thermal transfer; thereby abrogating thermally induced scaling or fouling difficulties associated with heating of the thermal receiving fluid. Wherein further, the available quantity of direct contact thermal energy transferred from the working media into the thermal receiving fluid is substantively elevated by the enthalpy of vaporization of the working media as it transitions from vapor phase to liquid phase while directly contacting said thermal receiving fluid.

Heat transfer processes have purveyed essential benefits to human activity since prehistory, from the natural use of sunlight for body warmth, to the use of fire for cooking and habitat comfort as well the use of water and ice for cooling and preserving food. In modern society, heat transfer processes are exploited in all realms of human activity such as, but not limited to, cooking, space heating and cooling, fabrication, warfare, transportation, generation of light, preservation of food, medicinal care, chemical and industrial processes, to name a typical few.

Essentially, all heat transfer processes employ one or more of three possible methods: conductive, convective, and radiative. Conductive heat transfer is a process wherein heat energy transfers in a body to facilitate the molecular vibratory energy balance of the body. A body with uneven temperatures therein will transfer vibratory heat energy internally until all the matter constituting the body is at an equal molecular vibratory level facilitating equal temperature throughout the body. Since the total body energy must be conserved; the colder regions of the body warm (gaining molecular vibrational energy and the warmer regions of the body cool (losing molecular vibrational energy). This thermal equalization internal to a solid body is primarily conduction of heat in the solid body. The transference of heat into or out of a solid body however is usually a combination of conduction and the two other methods of heat transfer, convection and/or radiation wherein convection is normally associated with a liquid, gas and/or plasma contact with said solid body and radiative is generally associated with electromagnetic field interaction on said body.

An example of conductive heat transfer is the transference of heat through the solid wall of a metal tubular heat exchanger wherein; as an example, if the inside wall surface of the heat exchanger tube is at a higher temperature than the outside wall surface of the heat exchanger tube, then such conditions would proffer conductive heat transfer through the solid tubing metal from the inside wall to the outside wall of the tubing. In a similar fashion if the inside wall surface of said heat exchanger tube is at a lower temperature than the outside wall surface of said heat exchanger tube then such conditions would proffer conductive heat transfer through the tubing metal from the outside wall to the inside wall of the tubing.

The convective method of heat transfer employs the physical transport (convection) and blending of heated or cooled matter from a corresponding warm region to a cool region or from a corresponding cool region to a warm region. Wherein, respectively, the blending of the heated or cooled matter results in a net temperature rise or fall of the mixture This heated or cooled matter may be a solid, gas, liquid or plasma, albeit typically the convecting matter is a liquid or gas. Hereafter, for purposes of this discussion, the temperature transporting convecting matter will be collectively referenced as “media”.

Convective heat transfer generally incorporates three steps. The first entails heating (or cooling) of a media by at least one thermal source (or sink). The second entails physical transport and mixing of the heated (or cooled) media with additional similar or differing media which is of cooler (or higher) temperature. The third step entails heat transfer within the hot media and the cold media mixture. Convective heat transfer, in typical applications, is generally associated with thermal transfer involving liquids and gases. Convective heat transfer is the primary means of heat transfer employed in the art of the invention herein.

Radiative heat transfer differs substantially from conductive and convective heat transfer. This method of heat transfer follows as electromagnetic energy emitted from a thermal source is absorbed by a thermal sink. Said electromagnetic energy induces molecular vibration in the absorbing matter, thereby purveying warmth. Radiative heat transfer is the only heat transfer method in which heat can be transferred from a thermal source to a thermal sink across open space. In general, radiative heat transfer processes are employed for heating purposes and rarely for cooling other than those situations wherein a warm body radiates and loses energy to cooler surroundings purveying energy loss and resultant cooling of said body.

All three means of heat transfer are employed in industry, with conductive and convective being predominant. Generally, industrial processes employ a combination of conductive and convective heat transfer for heating and/or cooling. A typical application would be heating of a cool fluid by a heat exchanger tube conveying a hot media such as steam, wherein the steam bearing tube would be ensconced within said cool fluid. The associated heat transfer process with such an application primarily employs both convective and conductive heat transfer processes. Heat transfer impediments are common in such applications as well as most other applications. An example of a critical impediment to heat transfer in such an application and many similar applications is the necessity to provide separation of the thermal source (steam) and the thermal sink (cool fluid). In this application such separation is necessary to prevent steam condensate (water) to mix with the cool fluid. The mechanism of separation in such an example is the tubing conveying the steam. There are convective heat transfer impediments (due to flow and surface conditions) on both the internal and external tubing surfaces as well as the impedance of relatively slow conductive heat transfer through the tubing material itself.

There are many fluids and/or solutions which experience chemical or physical alterations when heated or cooled. Frequently, these alterations result in the formation or precipitation of generally solid, thermally insulating deposits, often referenced as scale. Solid heating surfaces transferring heat into or out of such liquids are prone to become coated with layers of this accumulating, thermally insulating matter. Consequentially, heat transfer rates degrade substantially, wherein eventually the heat transfer process must be discontinued to facilitate chemical and/or mechanical removal of the thermally insulating deposits. This maintenance process is typically referenced as descaling.

Expensive and maintenance-intensive mechanical methods for continuous or periodic mechanical descaling of heat exchange surface have been employed. These technologies, typically referenced as scraped wall or scraped surface heat exchangers, are often employed wherein scaling, fouling, or coating materials collect on heat transfer surfaces. Multiple U.S. patents have been granted to such art. The reader is referenced to the following U.S. Patent examples Nos. 6,675,877, 5,485,880, and 4,282,925 relating to scraped surface heat exchangers. Scraped surface heat exchangers are expensive and suffer from wear of the heat exchanger surface area being scraped and consequently substantial maintenance cost and extended reparation downtime ensue.

Another approach for reducing scaling difficulties is taught in U.S. Pat. Nos. 4,616,698, and 4,554,963 wherein a fluidized bed of solids is employed within contact of the heat transfer surfaces. The fluidized, agitating bed of solids abrades scale from the heat transfer surfaces. This approach suffers from several deficits. In addition to abrading/abrogating scale on the heat transfer walls the agitating fluid bed of solids also markedly abrades and wears the heat transfer surfaces themselves, resulting in accelerated replacement/maintenance frequency. Additionally, the solids comprising the bed are prone to conveyance/loss from the heat exchanger with consequential deposition and/or damage affliction downstream from the fluidized bed material.

Another prevalent method to control scaling on heat transfer surfaces, especially common when heat transfer drives vaporization or evaporation processes, is periodic or continual discharge (blowdown) of the fluid being heated, wherein this blowdown is accompanied by equal volumes of fresh fluid makeup. This technique provides control of the concentrations of scaling and fouling materials in the fluid; thereby minimizing precipitation or agglomeration on heat transfer surfaces. Blowdown and fresh fluid makeup however result in loss of fluid volume (blowdown volume) and requisite replacement thereof. To control scaling tendencies many heat transfer processes employ chemical treatment of the heating or cooling source fluid to control scaling and and/or minimize the blowdown and makeup volume requirements. Consequently, blowdown is often entrained with residual descaling chemicals and associated by-products. These materials are usually expensive and often chemically hazardous, inciting handling difficulties and expenses, as well as environmental liabilities related with treating and disposal of blowdown volumes. Further, control of scaling by means of blowdown and makeup require monitoring of liquid properties for maintenance of appropriate blowdown and makeup rates. Excursions from the required control of blowdown and makeup rates often result in heat transfer failure and/or excess maintenance expense as well as discharge liabilities if the resulting scale buildup is excessive and blowdown is rendered hazardous due to the necessity for chemical scale suppressing additives.

As discussed in the foregoing, the heat transfer walls also purvey separation for materials on opposing sides of said walls. Aggressive fluids being heated or cooled often instigate corrosion and chemical attack upon solid heat transfer walls endangering the mechanical integrity of these surfaces, consequently compromising the requisite fluid separation, process quality, heat exchanger longevity and possibly safety. Also, chemical attack on heat exchanger equipment is often provoked by chemicals and additives prescribed to reduce or remove scaling and fouling of the heat transfer surfaces. In such cases, industry generally accepts marginal heat transfer performance and associated expense or exploits chemically insensitive exotic and expensive alloys for the heat transfer surfaces.

Another occasionally exploited direct contact heat transfer process used for heat transfer to scaling, fouling liquids is taught by U.S. Pat. No. 2,820,620 wherein bubbling hot gases are passed through a scaling, fouling liquid. The hot gases rise through the liquid transferring heat in a direct contact mode. These occasionally used processes are usually referenced as submerged flame evaporators. A similar process wherein superheated steam is employed as the hot contacting gas has also been employed in industry. The common disadvantage of the hot gas version of this technology is the energy required to both heat the gas and pressurize the gas for submerged release. An additional serious problem with both the hot gas and steam versions of this technology has been foaming and misting fluid carryover into the atmosphere and surrounding environment resulting from hot gas and/or steam bubbles bursting from the surface of the fluid being heated.

Immiscible, direct contact, liquid to liquid, heat transfer has been proposed and has been incorporated into limited applications as has been taught by the inventor herein as U.S. Pat. No. 6,119,458. A primary advantage of the immiscible, direct contact, liquid to liquid heat transfer process is the lack of solid heat transfer walls/surfaces prone to deposition and agglomeration of scaling and fouling materials. A focus of this prior art was for absorption of heat from scaling and fouling, hot brines (especially such as geothermal brines) into immiscible working fluids which vaporize under pressure for expansive employment to engender mechanical work or electrical generation. Absorption of heat in these prior art paradigms specify the immiscible working fluids be of a density lower than the liquid of which they are in immiscible direct contact. The inventor of the subject art herein has also previously taught the employ of lower density, single phase working fluids for direct contact heat transfer into highly scaling fluids: the reader is again referenced to U.S. Pat. No. 6,119,458. The novel subject art herein teaches no pressurization and in contrast to the lower density specifications of the prior art, the subject art specifies the working media liquid to be of a higher density than the fluid of immiscible direct contact. Further, the end state of the working media in many of the examples of the prior art is vaporous and requires external cooling to a liquid state for reuse wherein the end state teaching of the subject art herein is liquid simply requiring reheating for reuse.

There are multiple U.S. patents which teach the art of immiscible, direct contact heat transfer. The reader is referenced to the following U.S. Pat. Nos. 6,119,458, 1,905,185, 3,164,957, 3,988,895, 4,063,419, 4,081,975, 4,120,158 and 11,211,231.

Radiative heating-based processes have also been employed for the heating of scaling, fouling or corrosive liquids. This technique is successful, albeit generally energy inefficient. Radiative heating has been used for the heating of materials amenable to electromagnetic radiation absorption. A common example of such art is microwave ovens for heating water entrained foods and drinks. Relative to the art taught in these processes the reader, is referenced to U.S. Pat. Nos. 11,153,943, 11,140,913, 11,129,674 and 11,211,231.

Various embodiments of the invention described herein proffer high efficiency heating of a cooler fluid, wherein said cooler fluid may be highly scaling such as, but not limited to, aqueous brine entrained with highly scaling prone mineral salts or aggressive such as acidic or caustic fluids. These embodiments purvey heating of the cooler fluid by immiscible, direct contact with a hotter, higher liquid density, phase transitioning liquid working media wherein the lack of solid wall heat transfer surfaces eliminates concerns related to the scaling characteristics of the fluid being heated or the otherwise aggressive nature of said cooler fluid.

Wherein further, various embodiments proffer phase shifting, density differential motivated fluid flow dynamics minimizing the need for pumping and piping conveyance costs and associated energy use.

Wherein further various embodiments provide not only sensible heat transfer, as is common in the prior art, but also of great merit is the invention also uniquely proffers copious quantities of non-sensible heat transfer provided by the enthalpy of vaporization as the working media in a heated vapor phase transitions into an immiscible liquid phase while in direct contact with the cooler fluid.

Wherein also the direct contact, heat transfer physics of the invention are optimized by the generation of larger contacting surface area as the relative contact velocity decreases as well as the generation of higher relative contact velocity as the contacting surface area decreases thereby fostering enhanced direct contact, convective heat transfer performance.

### SUMMARY OF THE INVENTION

Embodiments of the present invention relate to a heat transfer process, particularly beneficial for heating highly scaling prone or otherwise aggressive fluids without scaling or corrosive damage to heat transfer surfaces. This heat transfer process, as described herein, facilitates heat transfer into a fluid so as to raise the temperature of the fluid by means of direct physical contact between the fluid and an immiscible, phase shifting, working media such as, but not limited to perfluorocarbons, wherein said working media has at least the following characteristics: 1) minimal solubility for solutes or solids entrained within the fluid to be heated, 2) the liquid phase of the working media has a higher density than the fluid to be heated, 3) the vapor phase of the working media has a lower density than the fluid to be heated, 4) the boiling temperature of the working media exceeds the desired temperature of the fluid to be heated.

Various embodiments of the present invention include a novel immiscible direct contact, heat transfer process wherein the liquid phase of a phase shifting (liquid to vapor to liquid) working media is heated, vaporized and then condensed while servicing immiscible, direct contact heating of a cooler fluid. The art described herein is presented in three, but not limited to three, embodiments. In each embodiment the heat transfer process is similar wherein the variance is primarily of functioning structural nature.

In one embodiment of the invention a fluid to be heated is underlain by a stratum of denser, immiscible, phase shifting enabled liquid (the liquid phase of the working media of the invention) wherein the liquid in said stratum engulfs the heating means of a heating appliance therein. Heat from said appliance induces boiling and vaporization of the working media underneath the overlying immiscible cooler fluid.

Vaporous working media bubbles rise upward from the boiling working media entering into and ascending upward in the overlaying cooler fluid. As the heated working media bubbles ascend in the cooler overlaying fluid direct contact between the hot ascending bubbles and the surrounding cooler fluid transfers heat into the cooler surrounding fluid. As the working media bubbles rise and transfer heat to the surrounding fluid the vaporous working media enveloped in the rising bubbles envelopes condenses into working media liquid. This condensation releases the copious latent heat of vaporization of the working media, therein protracting heat transfer into the surrounding cooler fluid.

As the bubbles rise and heat transfers into the surrounding fluid, condensate of the working media vapor collects internal to the envelopes of the rising bubbles thereby increasing the net density of the bubbles. Said increasing net bubble density slows the ascension rate of the bubbles until eventual reversal occurs. The now descending bubbles continue condensation of vaporous working media into liquid working media proffering the continued release of the latent heat of vaporization into the surrounding fluid.

The descending bubble envelopes containing liquid working media and any residual working media vapor eventually exit the cool fluid body returning to the underlying liquid working media stratum wherein said returning liquid working media is once again heated to vaporization and the heat transfer process cycle continues.

In said embodiments of the invention, enhanced thermal energy transfer is further provided by the increased thermal contact surface area generated by expansion of the working media bubbles during ascent in the decreasing hydrostatic pressure of the cool fluid column. This growth of contacting surface area of the ascending bubbles mitigates the convective heat transfer reduction associated with slowing of the bubbles ascent within the surrounding cool fluid. In a similar fashion, the heat transfer loss resulting from the reduction of the surface area of the shrinking, descending bubbles is mitigated by the improved convective heat transfer associated with the accelerating descent of bubbles within the surrounding cooler fluid.

A further benefit in said embodiment of the invention is the direct contact fluid dynamics is conveyed by thermally motivated density differentials between the working media and the cooler fluid; therein minimizing the need and expense of pumping appliances, attendant conveyances and energy associated therein.

In a second embodiment of the invention the heat and mass transfer processes are essentially identical to the foregoing embodiment with the exception that heating of the liquid working media of the invention underlying the cooler fluid is externally provided wherein one or more heating appliances are external to the liquid working media stratum underlying the fluid body. In this second embodiment, liquid working media underlying the cool fluid body is conveyed to one or more heat appliances for vaporization wherein vaporous working media is return conveyed to facilitate direct contact ascension of hot, vaporous bubbles within the overlying cool fluid body.

In a third embodiment of the invention, the heat and mass transfer processes are essentially identical to the foregoing embodiments with the exception of collection and discharge conveyance of solids generated from the heated fluid. In this third embodiment, one or more solids collection and removal means are provided to service those applications wherein the cool fluid being heated is prone to solids deposition such as caused by, but not limited to, agglomeration, generation, and/or precipitation. Of particular focus for applications of said third embodiment are those solids entrained fluids exhibiting reverse solubility. Heating of such fluids by means of hot surfaces rapidly plaques such surfaces with solids deposition wherein these solids often form a hard, thermally insulating scale coating which dramatically impedes heating of said fluids. This third embodiment of the invention employs the same direct contact phase shifting heat transfer art as the previous embodiments wherein there are no solid heat transfer surfaces prone for scale deposition. The precipitates instead form as suspended solids in the heated fluid. This third embodiment includes one or more solids sediment collection regions and associated porting for separation and external conveyance of said solids.

Wherein summarizing some of the multiple and novel advantages proffered by the art of the invention are as follows but not limited therein:
Chemical scale inhibitors and solids dispersants are not required, eliminating the associated expense and potential handling hazards.
Heat transfer reliability is enhanced in applications with varying fluid quality and constituents wherein the scaling propensity of the heating serviced fluid varies.
Personnel and environmental hazards associated with chemical scale inhibitors and solid dispersants are eliminated.
Heat transfer surface cleaning maintenance is unwarranted, reducing the associated expense, downtime and potentially hazardous chemical usage.
Aggressive heat transfer surface cleaning agents and accompanying cleaning operations are unwarranted, eliminating the requirements for exotic or thermally compromising materials necessary to withstand the detrimental effects of cleaning chemicals and associated operations.
Chemical scale and corrosion inhibitors and dispersants are not employed thereby affording the safety, convenience, and assurance of chemical free liquids blowdown, if needed.
There are no heat transfer surfaces requiring exotic hard or thick materials, or mechanical or hydraulic complexities as are associated with scraped wall or fluidized bed abrading solids entrained liquid heat transfer processes.
Energy transfer is efficient and environmentally clean proffering no maintenance, plugging, fouling or air pollution potential in contrast to such hindrances associated with submerged flame heat transfer processes.
Heating vapor condensation contamination, such as burdens steam injection heat transfer processes is eliminated by the immiscible nature of the phase shifting heat transfer working media.
Heat transfer is efficient and direct without the energy inefficiencies associated with microwave or radiative heat transfer processes.
As a consequence of the thermally induced, density motivated fluid dynamics, pumping capital cost and associated energy consumption is minimized.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a schematic illustration of one embodiment of the present invention wherein hot vaporous bubbles of a phase shifting media ascend in immiscible, direct contact heating, with an overlaying cooler fluid body to be heated;

FIG. 2 is a schematic illustration of another embodiment of the present invention wherein the direct contact fluid dynamics of the working media and the fluid being heated is motivated by thermally driven density differentials between the working media and cooler fluid minimizing the need for pumping appliances, conveyances and associated energy requirements; and

FIG. 3 is a schematic illustration of an embodiment wherein solids form and/or gather within the fluid as it heats. As a consequence of the fluid dynamics being generally centralized in the direct contacting process, the thermally formed solids generally settle downward in the outer, less dynamic region of the process. Said solids therein settle downward into one or more collection regions which are serviced for solids discharge by one or more externally oriented conveyance ports.

### DESCRIPTION OF THE PREFERRED EMBODIMENTS

The present invention is directed to improved methods and systems for, among other things, heat transfer process. The configuration and use of the presently preferred embodiments are discussed in detail below. It should be appreciated, however, that the present invention provides many applicable inventive concepts that can be embodied in a wide variety of contexts other than heat transfer process. Accordingly, the specific embodiments discussed are merely illustrative of specific ways to make and use the invention, and do not limit the scope of the invention.

The present invention will be described with respect to various embodiments in a specific context, namely as a heat transfer process and associated embodiments which can be used for heating a fluid, wherein said fluid may be potentially aggressive, scaling or otherwise generative of solids by employ of direct contact heat exchange between at least one immiscible, phase shifting working media wherein the liquid phase of said working media is of a higher density than the fluid being heated and wherein further the boiling temperature of the working media is higher than the desired heating temperature of the cooler fluid to be heated. Wherein further solutes or solids in the fluid to be heated are essentially insoluble in the working media. Wherein further the direct contacting fluid dynamics are primarily motivated by thermally induced phase shifting density variation between the working media and the fluid being heated.

There are many features of the heat transfer process, device implementations or embodiments disclosed herein, of which one, a plurality, or all features or steps may be employed in any implementation or embodiment.

In the following descriptions, reference is made to the accompanying Figures which form a part hereof, and which show by way of illustration, possible enactments of the invention. It should be understood that other implementations and embodiments may be utilized, and structural, as well as procedural, changes may be made without departing from the scope of this disclosure. As a matter of convenience, various components will be described using exemplary materials, sizes, shapes, dimensions, and the like. However, the invention is not limited to the stated implementations and examples and other configurations are possible and within the teachings of the present disclosure.

A heat transfer process and some associated embodiments are described herein with respect to implementations in specific contexts. Furthermore, it should be appreciated by those skilled in the art that the conception and specific implementations disclosed may be readily utilized as a basis for modifying or designing other structures or processes for carrying out similar purposes such as, but not limited to, cooling of a fluid pursuant to similar employ of the art described in the present disclosure. It should be realized by those skilled in the art that such equivalent constructions do not depart from the spirit and scope of this disclosure.

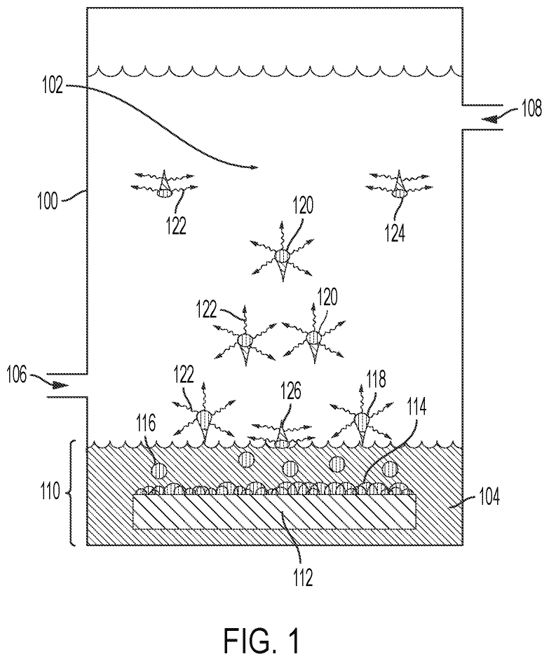

Referring now to FIG. 1 which incorporates at least one contacting vessel 100 encompassing at least two immiscible fluid/liquids of differing density. Wherein fluid 102 has a lower density and is to be heated and liquid working media 104 is a higher density liquid phase of one or more phase shifting working medias. Wherein further the liquid phase of working media 104 has a boiling temperature higher than the desired heating temperature of fluid 102 and liquid working media 104 has minimal solubility for solids entrained within fluid 102. Vessel 100 also incorporates at least one inlet conveyance 106 for conferring cool fluid 102 into vessel 100 and at least one outlet conveyance 108 for discharge of heated fluid 102 from vessel 100.

As a consequence of immiscibility and density differential, collection of liquid working media 104 ensues below fluid 102 herein illustrated as stratum layer 110. One or more heating appliance(s) 112 are immersed and in direct thermal contact with the liquid working media 104 of the stratum layer 110. Thermal contact between heating appliance(s) 112 and the liquid working media 104 of the stratum layer 110 results in vaporization 114 of the liquid working media 104. Heated, low density vaporous bubbles 116 of working media 104 buoy upward 118 into the overlaying body of fluid 102 and continue to rise 120 in direct, immiscible contact with fluid 102. The temperature difference between the hotter ascending bubbles 120 and the surrounding cooler fluid 102 promotes heat transfer 122 from the bubbles 120 into the surrounding fluid 102. As thermal energy exits bubbles 120 the vaporous working media 104 in the bubbles 120 condenses within the bubble envelopes into liquid working media 104 proffering the copious thermal energy release of the enthalpy of vaporization of working media 104, therein markedly protracting heat transfer 122 into the surrounding fluid 102.

As heat transfer 122 fosters condensation of vaporous working media 104 into liquid working media 104 the net density of bubbles 120 increases, thereby slowing and eventually reversing the ascent of bubbles 120 in fluid 102.

The now descending bubbles 124, continue to transfer heat into the surrounding fluid 102 wherein protraction of heat transfer proffered by condensation of vaporous working media 104 into liquid working media 104 continues. The net density of descending bubbles 124 increases as liquid 104 accumulates within the envelope of bubbles 124. Said increase of bubble 124 density fosters downward acceleration and higher relative velocity between the descending bubbles 124 and surrounding fluid 102 thereby enhancing convective heat transfer between bubbles 124 and the surrounding fluid 102.

The descending bubbles 124 return 126 to the stratum layer 110 of liquid working media 104 wherein the returning working media 104 is reheated to regenerate vaporous bubbles 114 which rise 116 and re-enter 118 fluid 102 and the heat transfer process cycle continues.

The simple and novel features of the process and embodiment described herein purvey heating a potentially aggressive fluid 102 through the employ of immiscible direct contact between said fluid and a phase shifting, working media 104 wherein further the primary direct contact flow dynamics are motivated by density differentials associated with thermally induced phase shifting in bubbles of working media 104.

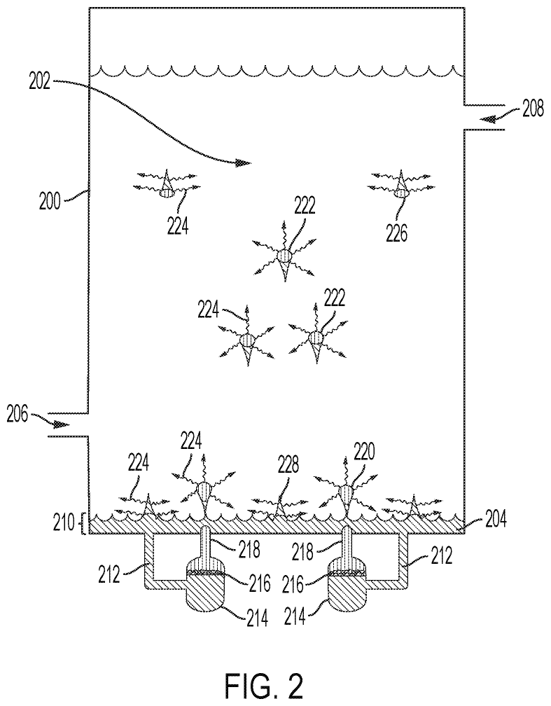

A process illustration of another embodiment of the invention is illustrated on FIG. 2. This embodiment incorporates at least one contacting vessel 200 encompassing at least two immiscible fluids/liquids of differing density. Wherein fluid 202 has a lower density and is to be heated and liquid working media 204 is a higher density liquid phase of one or more phase shifting working medias. Wherein further the liquid phase of working media 204 has a boiling temperature higher than the desired heating temperature of fluid 202 and liquid working media 204 has minimal solubility for solutes or solids entrained within fluid 202. Vessel 200 also incorporates at least one inlet conveyance 206 for conferring cool fluid 202 into vessel 200 and at least one outlet conveyance 208 for discharge of heated fluid 202 from vessel 200.

As a consequence of immiscibility and density differential, liquid working media 204 settles to a collection sump 210 in the lower region of vessel 200 wherein said sump 210 underlies fluid 202. Liquid working media 204 conveys 212 from sump 210 of vessel 200 to one or more external heating appliances 214 for heating and vaporization 216. Hot vaporous working media 204 is conveyed 218 back into vessel 200 and buoys upward 220 into fluid 202. Bubbles of hot vaporous working media 204 rise upward 222 in immiscible direct thermal contact with fluid 202. The temperature difference between the hotter ascending bubbles 222 and the surrounding cooler fluid 202 promotes heat transfer 224 from the bubbles 222 into the surrounding fluid 202. As thermal energy exits bubbles 222 the vaporous working media 204 in the bubbles condenses within the bubble envelopes into liquid working media 204 proffering the copious thermal energy release of the enthalpy of vaporization of working media 204, therein markedly protracting heat transfer 224 into the surrounding fluid 202.

As heat transfer 224 fosters condensation of vaporous working media 204 into liquid working media 204 the net density of bubbles 222 increases, thereby slowing and eventually reversing the ascent of bubbles 222 in fluid 202.

The now descending bubbles 226, continue to transfer heat 224 into the surrounding fluid 202 wherein protraction of heat transfer proffered by condensation of vaporous working media 204 into liquid working media 204 continues. The net density of descending bubbles 226 increases as liquid working media 204 accumulates within the envelope of bubbles 226. Said increase of bubble 226 density fosters downward acceleration and higher relative velocity between the descending bubbles 226 and surrounding fluid 202 thereby enhancing convective heat transfer between the bubbles 226 and the surrounding fluid 202.

The descending bubbles 226 return 228 to the sump 210 wherein the returning working media 204 is conveyed 212 to one or more external heat appliances 214 wherein the liquid working media 204 is reheated to regenerate vaporous bubbles 216 of working media 204. Vaporous working media 204 is conveyed 218 into vessel 200 for direct contact heating of fluid 202 and continuation of the heat transfer process cycle.

The simple and novel features of the process and embodiment described herein purvey heating a potentially aggressive fluid 202 through the employ of immiscible, direct contact between said fluid 202 and an externally heated phase shifting, working media 204 wherein the primary flow dynamics are motivated by density differentials associated with thermally induced phase shifting of bubbles of working media 204.

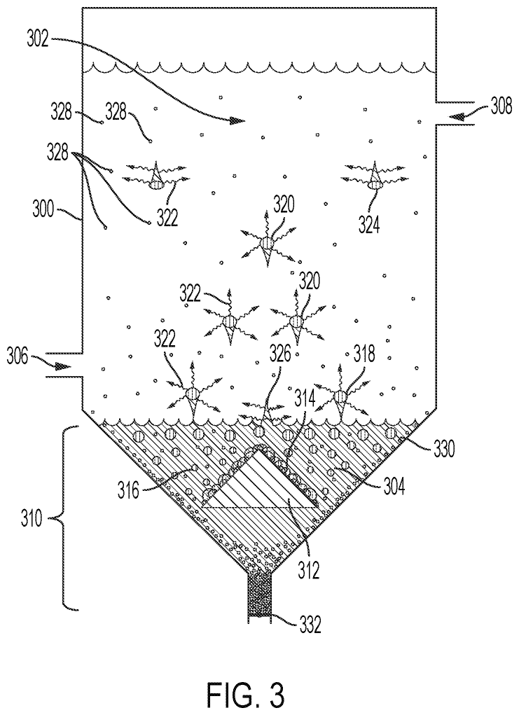

A process illustration of another embodiment of the invention is illustrated on FIG. 3. This embodiment facilitates heat transfer into one or more solids bearing fluids 302 wherein said solids form and/or precipitate as a consequence of heating fluid 302. This embodiment incorporates at least one contacting vessel 300 encompassing at least two immiscible liquids/fluids of differing density: fluid 302 being of a lower density and entrained with thermally sensitive solids, liquid working media 304 being a higher density, phase shifting, working media. Wherein further the liquid phase of working media 304 has a boiling temperature higher than the desired heating temperature of fluid 302 and liquid working media 304 has minimal solubility for solids entrained within fluid 302. Vessel 300 also incorporates at least one inlet conveyance 306 for conferring cool fluid 302 into vessel 300 and at least one outlet conveyance 308 for discharge of heated fluid 302 from vessel 300. Vessel 300 further incorporates one or more solids collection regions 330 serviced by one or more external conveyance ports 332 for solids collected in collection regions 330.

As a consequence of immiscibility and density differential, collection of the working media 304 ensues below fluid 302 herein illustrated as stratum layer 310. One or more heating appliances 312 are in thermal contact with the liquid media 304 of the stratum layer 310. Thermal contact between heating appliance 312 and the liquid working media 304 of the stratum layer 310 results in vaporization 314 of the liquid working media 304 of the stratum layer 310. Vaporous bubbles 316 of working media 304 buoy upward 318 into the overlaying body of fluid 302 and continue to rise 320 in direct contact with fluid 302. The temperature difference between the hotter ascending bubbles 320 and the surrounding cooler fluid 302 promotes heat transfer 322 from the bubbles 320 into the surrounding fluid 302. As thermal energy exits bubbles 320 the vaporous working media 304 in the bubbles condenses into liquid working media 304 proffering the copious energy release of the enthalpy of vaporization of working media 304, therein markedly protracting the heat transfer 322 into the surrounding fluid 302.

As heat transfer 322 fosters condensation of vaporous working media 304 into liquid working media 304 within the bubble envelopes, the net density of bubbles 320 increases, thereby slowing and eventually reversing the ascent of bubbles 320 in fluid 302.

The now descending bubbles 324, continue to transfer heat into the surrounding fluid 302 wherein protraction of heat transfer proffered by condensation of vaporous working media into liquid working media continues. The net density of descending bubbles 324 increases as liquid working media 304 accumulates within the envelope of bubbles 324. Said increase of bubble 324 density fosters downward acceleration and higher relative velocity between the sinking bubbles 324 and surrounding fluid 302 therein enhancing heat transfer convection between the bubbles 324 and the surrounding fluid 302.

The descending bubbles 324 return 326 to the stratum layer 310 of liquid 304 wherein the returning working media 304 is reheated 314 to regenerate vaporous bubbles 316 of working media 304 and the heat transfer process into fluid 302 continues as bubbles 318 ascend into fluid 302.

Solids 328 engendered in the heat transfer process 322 or otherwise entrained within fluid 302 settle for collection in one or more catchment regions 330 in vessel 300 wherein said catchment regions 330 are serviced by one or more conveyance ports 332 for solids removal from the heat transfer process 322.

The simple and novel features of the process and embodiment described herein purvey heating a potentially aggressive, solids engendering fluid 302 through the employ of direct contact heating between said liquid and an immiscible, phase shifting, working media 304 wherein primary flow dynamics are motivated by density differentials associated with thermally induced phase shifting of working media 304.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for heat transfer process known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

I claim:

1. A method for heating a fluid comprising:
heating, boiling and vaporizing a liquid working media;
direct contact introduction of vaporous heated bubbles of said liquid working media into a fluid; wherein
said heated bubbles ascend within said fluid while transferring heat to said fluid via direct contact therewith;
thermal energy is transferred from said ascending heated bubbles which affects condensation of said liquid working media within said heated bubbles creating vaporous working media resulting in provision of latent heat of vaporization to a direct contact heating process;
condensation of said vaporous working media promotes higher net density of said heated bubbles thereby slowing and eventually reversing ascension of said heated bubbles and ultimately resulting in descending bubbles; and
said descending bubbles continue direct contact transference of heat into said fluid until primarily liquid working media bubbles exit a lower level of said fluid, whereupon said liquid working media is again heated, vaporized and reintroduced into said fluid for continued direct contact heating thereof.

2. The method of claim 1, wherein said working media is primarily immiscible with said fluid.

3. The method of claim 1, wherein density of a liquid phase of said working media is greater than density of said fluid.

4. The method of claim 1, wherein a liquid phase of said working fluid has a boiling point greater than a required heating temperature of said fluid.

5. The method of claim 1, wherein a liquid phase of said working media has minimal solubility for solutes or suspended solids entrained within said fluid.

6. A method for heating and extracting thermally affected solids from solids-bearing fluid comprising;
heating, boiling and vaporizing a liquid working media;
direct contact introduction of vaporous heated bubbles of said liquid working media into a solids-bearing fluid; wherein
ascension of said heated bubbles within said solids-bearing fluid wherein said solids-bearing fluid is heated heats via direct contact with said rising heated bubbles and wherein an increase in temperature of said solids-bearing fluid engenders solids formation from said solids-bearing fluid;
thermal energy is transferred from said ascending heated bubbles which affects condensation of said liquid working media within said heated bubbles creating vaporous working media resulting in latent heat of vaporization to a direct contact heating of said solids-bearing fluid and facilitating extraction of solids from said solids-bearing fluid;
condensation of said vaporous working media promotes higher net density of said heated bubbles thereby slowing and eventually reversing ascension of said heated bubbles and ultimately resulting in descending bubbles; and
said descending bubbles continue direct contact transference of heat into said solids-bearing fluid further facilitating solids extraction from said solids-bearing fluid until said descending bubbles exit a lower level of said solids-bearing fluid, whereupon said descending bubbles become said liquid working media which is again heated, vaporized and reintroduced into said solids-bearing fluid for continued direct contact heating and solids extraction thereof.

7. The method of claim 6, wherein solids extracted by heating said solids-bearing fluid collect in one or more catchment regions of a vessel wherein said catchment regions are serviced by porting for external conveyance of said extracted solids.

8. The method of claim 6, wherein said working media is primarily immiscible with said solids-bearing fluid.

9. The method of claim 6, wherein density of a liquid phase of said working media is greater than density of said solids-bearing fluid.

10. The method of claim 6, wherein a liquid phase of said working fluid has a boiling point greater than a required solids extraction heating temperature of said solids-bearing fluid.

11. The method of claim 6, wherein a liquid phase of said working media has minimal solubility for solids entrained within said solids-bearing fluid.
